(19) United States
(12) Patent Application Publication
(10) Pub. No.: US 2013/0172475 A1
(43) Pub. Date: Jul. 4, 2013

(54) ALIPHATIC POLYUREA COATING, THE METHOD FOR PREPARING THE SAME AND THE USE THEREOF

(71) Applicants: Frank Zhang, Shanghai (CN); Jianping Shen, Shanghai (CN)

(72) Inventors: Frank Zhang, Shanghai (CN); Jianping Shen, Shanghai (CN)

(73) Assignee: Bayer Intellectual Property GmbH, Monheim (DE)

(21) Appl. No.: 13/807,029

(22) PCT Filed: Jun. 27, 2011
(86) PCT No.: PCT/EP2011/060733

§ 371 Date: Feb. 19, 2013

(30) Foreign Application Priority Data
Jun. 29, 2010 (CN) 201010213488.8

(51) Int. Cl. C09D 175/02

(52) U.S. Cl. CPC C09D 175/02
USPC 524/537

(57) ABSTRACT

The present invention pertains to an aliphatic polyurea coating, comprising a product mixed by the components including NCO-terminated polycarbonate diol modified and/or of ether polyol modified isophorone diisocyanate (IPDI) prepolymer; hexamethylene diisocyanate (HDI) oligomers; and amino resin comprising sterically hindered secondary aliphatic diamines. The aliphatic polyurea coating layer prepared by the aliphatic polyurea coating presented in this invention possesses good elongation and tensile strength, good flexibility in low temperature, good abrasion resistance, good adhesion property, good weatherability and good chemical resistance.

### TECHNICAL FIELD

The present invention pertains to coating field, in particular, pertains to aliphatic polyurea coating, the method for preparing the same and the use thereof.

### BACKGROUND

As we know, the conventional polyurethane (polyurea) waterproofing coatings comprised single-component manual application aromatic polyurethane waterproofing coatings, two-component manual application aromatic polyurethane waterproofing coatings and two-components spraying aromatic waterproofing coatings.

By using the aromatic polyisocyanate compound (such as MDI, TDI and the adducts or oligomers thereof) as coating binder, the weatherabilities of the conventional coatings were poor. The conventional coatings were easy to be yellowing and chalking after being exposed outdoor, which would affect not only the mechanical properties, the service life of the waterproofing layer, but also the decorative performance thereof. Therefore, it was difficult for the conventional coatings to meet the requirements of being used and exposed outdoor directly. Some parts of the high speed railway bridge would be used and exposed under sun light directly, therefore the conventional polyurethane (polyurea) waterproofing coatings were limited to be applied on the high speed railway bridges, due to the fact that the conventional polyurethane (polyurea) waterproofing coatings had limited weatherability.

With the development of railway in China, especially the high speed railway, the technical requirements of the coatings applied on high speed railway bridges were higher than earlier. In 2009, it had issued a strict and detailed specification for aliphatic waterproofing coatings applied on concrete bridges in Beijing-Shanghai high speed railway, wherein, the specification required a high level of mechanical properties and weatherability. For example, the aliphatic coatings should meet the following performances as elongation ≧200%, tensile strength ≧4 MPa, no obvious color changes, no chalking, no blisters and no cracks after 1500 h artificial accelerated UV aging test, furthermore, the aliphatic coating should be applied at room temperature.

At present there were several methods to improve the weatherability and mechanical strength of aliphatic coatings. For example, CN-A 1350018 (EP-A 1 184 399) disclosed a new polyurea coating based on IPDI and HDI, however, this polyurea coating was a kind of powder coating. The curing temperature of this polyurea coating was 150-220° C., therefore, this polyurea coating was not suitable for the operation under room temperature for curing. In addition, this coating did not possess waterproof property.

In another patent, CN-A 101277988 (W02007/039133) disclosed a coating binder comprising polyurethane prepolymer with allophanate and amine functional groups. However, the maximal elongation and the maximal tensile strength of the coating based on this binder were 61.5% and 2.4 MPa respectively, which is much less than the requirements of elongation ≧200% and tensile strength ≧4 MPa.

In addition, CN-A 101469246 disclosed a method for preparing waterproofing coating based on polyaspartics and polyisocyante. However, the maximal elongation of the coating prepared by this method was 150%, less then the requirement of elongation ≧200%.

In order to meet the practical requests of aliphatic waterproofing coatings, for example, elongation ≧200%, tensile strength ≧4 MPa, neither obvious color changes, nor chalking, no blister, no crack after 1500 h artificial accelerated UV aging test, and applicable at a room temperature, it was desirable to develop a new aliphatic polyurea coating and a coating layer based on aliphatic polyurea coating.

### CONTENTS OF INVENTION

The objective of this invention is to provide an aliphatic polyurea coating. According to one of examples in this invention, the aliphatic polyurea coating comprises a product mixed by the components including A, B and C:

A) 30-50 parts by weight of NCO-terminated polycarbonate diol modified and/or polyether polyol modified isophorone diisocyanate (IPDI) prepolymer;

B) 3-15 parts by weight of hexamethylene diisocyanate (HDI) oligomers; and

C) 10-25 parts by weight of amino resin comprising sterically hindered secondary aliphatic diamines

Preferably, the amount of the NCO-terminated polycarbonate diol modified and/or polyether polyol modified isophorone diisocyanate prepolymer is 33-44 parts by weight.

Preferably, the amount of the hexamethylene diisocyanate oligomers is 4-6 parts by weight.

Preferably, the amount of the sterically hindered secondary aliphatic diamine is 12-17 parts by weight.

Another objective of this invention is to provide a method for preparing an aliphatic polyurea coating. According to one of examples in this invention, the method comprises the step of mixing the components including A, B and C:

A) 30-50 parts by weight of NCO-terminated polycarbonate diol modified and/or polyether polyol modified isophorone diisocyanate prepolymer;

B) 3-15 parts by weight of hexamethylene diisocyanate oligomers; and

C) 10-25 parts by weight of amino resin comprising sterically hindered secondary aliphatic diamines.

Preferably, the amount of the NCO-terminal polycarbonate diol modified and/or polyether polyol modified isophorone diisocyanate prepolymer (A) is 33-44 parts by weight.

Preferably, the amount of the hexamethylene diisocyanate oligomers (B) is 4-6 parts by weight.

Preferably, the amount of the amino resin comprising sterically hindered secondary aliphatic diamine (C) is 12-17 parts by weight.

The third objective of this invention is to provide an aliphatic polyurea coating layer. According to one of examples in this invention, the aliphatic polyurea coating layer is the product of the aliphatic polyurea coating presented in this invention.

The aliphatic polyurea coating layer prepared by the aliphatic polyurea coating presented in this invention possesses good elongation and tensile strength, good flexibility in low temperature, good abrasion resistance, good adhesion property, good weatherability and good chemical resistance. The aliphatic polyurea coating presented in this invention has long potlife, therefore, it is fit for manual application. The aliphatic polyurea coating layer can be obtained by ways of spraying, rolling or brushing.

### MODE OF CARRYING OUT THE INVENTION

This invention provides an aliphatic polyurea coating comprising NCO-terminated polycarbonate diol modified and/or polyether polyol modified isophorone diisocyanate prepolymer (IPDI prepolymer), hexamethylene diisocyanate oligomers (HDI oligomers) and sterically hindered secondary aliphatic diamine

In the present invention, the average molecular weight of the NCO-terminated polycarbonate diol modified and/or polyether polyol modified isophorone diisocyanate prepolymer (A) can be selected from, but not limited to, 1500-3500, preferably 2200-3000. The NCO-content of the NCO-terminated polycarbonate diol modified and/or polyether polyol modified prepolymers can be selected from, but not limited to, 2.5-5.0% by weight, preferably 3.5-3.7% by weight, based on 100% by weight of the NCO-terminated polycarbonate diol modified and/or polyether polyol modified prepolymer.

The amount of the NCO-terminated polycarbonate diol modified and/or polyether polyol modified prepolymer is 30-50 parts by weight, preferably 33-44 parts.

The hexamethylene diisocyanate (HDI) oligomers can be selected from, but not limited to, hexamethylene diisocyanate trimer, hexamethylene diisocyanate biuret or hexamethylene diisocyanate uretdion, preferably hexamethylene diisocyanate biuret. The NCO-content of hexamethylene diisocyanate (HDI) oligomers can be selected from, but not limited to, 10-25% by weight, preferably 15-23.7% by weight, most preferably 22% by weight, based on 100% by weight of the hexamethylene diisocyanate (HDI) oligomers.

The amoune of the hexamethylene diisocyanate oligomers is 3-15 parts by weight, preferably 4-6 parts by weight.

The amino resin comprising sterically hindered secondary aliphatic diamine can be selected from, but not limited to, secondary aliphatic diamine with alicyclic compound modified, secondary aliphatic diamine with branched alicyclic compound modified or secondary aliphatic diamine with line aliphatic compound modified, preferably secondary aliphatic diamine with alicyclic compound modified. The amino equivalent of the amino resin comprising sterically hindered secondary aliphatic diamine can be selected from, but not limited to, 200-400, preferably 270-325, most preferably 277.

The amount of the amino resin comprising sterically hindered secondary aliphatic diamine is 10-25 parts by weight, preferably 12-17 parts by weight, most preferably 15 parts by weight.

In the present invention, the components for preparing the aliphatic polyurea coating can further comprise solvents, additives, pigments or fillers.

The solvents can be selected from, but not limited to, propylene glycol methyl ether acetate, xylene, butyl acetate or of hydrocarbon mixtures. The hydrocarbon mixtures can be selected from, but not limited to, paraffin series hydrocarbon mixture and naphthene series hydrocarbon mixture.

The amount of the solvents is 5-55 parts by weight, preferably 45-55 parts by weight.

The additives can be selected from the following group consisting of dispersing agent, leveling agent, wetting agent, defoamer agent, light stabilizer, matting agent and dewater agent.

The dispersing agent can be selected from, but not limited to, solution of a high molecular weight block copolymer with pigment affinity groups.

The leveling agent can be selected from, but not limited to, polyether modified methylalkylpolysiloxane copolymer solution.

The wetting agent can be selected from, but not limited to, polyether modified dimethylpolysiloxane copolymer.

The defoamer agent can be selected from, but not limited to, solution of foam destroying polymers and polysiloxanes.

The light stabilizer agent can be selected from, but not limited to, the combination of a liquid hindered amine light stabilizer (HALS) and a liquid UV absorber of the hydroxyphenyl-benzotriazole.

The matting agent can be selected from, but not limited to fumed silica matting powder with 10 μm average particle size.

The dewater agent can be selected from, but not limited to, p-Toluenesulfonyl isocyanate.

The amount of the additives is 1-10 parts by weight, preferably 5-10 parts by weight.

The pigments can be selected from, but not limited to, rutile type titanium dioxide, high strength amorphous carbon black, iron oxides, organic pigments.

The amount of the pigments is 0-50 parts by weight, preferably 20-30 parts by weight.

The fillers can be selected from, but not limited to, inorganic fillers, such as talc powder, barium sulphate powder, etc.

The amount of extenders is 0-50 parts by weight.

According to the method for preparing the aliphatic polyurea coating presented in this invention, the component A and B can be mixed at first to form a crosslinking part, and then stored in sealed can. The component C can be a co-reactant part and then stored in sealed can. Before preparing the aliphatic polyurea coating layer, the crosslinking part and the co-reactant part can be mixed to obtain an aliphatic polyurea coating.

The chosen solvents or additives can be mixed with component A and B at first to form a crosslinking part and stored in sealed can. The chosen solvents, additives, pigments or fillers can be mixed with component C to form a co-reactant part and stored in sealed can. Before preparing the aliphatic polyurea coating layer, the crosslinking part and the co-reactant part can be mixed to obtain an aliphatic polyurea coating.

According to the method for preparing the aliphatic polyurea coating presented in this invention, the component A, B and C can be stored in sealed can for use respectively. Before preparing the aliphatic polyurea coating layer, the component A, B and C can be mixed to obtain an aliphatic polyurea coating.

The chosen solvents or additives can be mixed with component A or B respectively at first to form two different crosslinking parts and then stored in sealed can for use respectively. The chosen solvents, additives, pigments or fillers can be mixed with component C at first to form a co-reactant part, and then stored in sealed can for use. Before preparing the aliphatic polyurea coating layer, the two crosslinking parts can be mixed with the co-reactant part, to obtain an aliphatic polyurea coating.

The aliphatic polyurea coating layer adhered to a substrate can be obtained by a spreading process, such as spraying, rolling or brushing, of the aliphatic polyurea coating provided in the present invention onto a surface of the substrate. The spreading process can be applied at a room temperature.

The substrate can be selected from, but not limited to, polyurea waterproofing layer, aromatic polyurethane waterproofing layer, epoxy coating layer, epoxy FRP, glass panel with a smooth and flat surface, tinplate panel with a smooth and flat surface after being sanded, aluminum panel with a smooth and flat surface after being sanded, PP panel with a smooth and flat surface after being sanded, standard Q-panel aluminum panel. The polyurea water-proofing layer, can be selected from, but not limited to, pure polyurea waterproofing layer, hybrid waterproofing layer with polyurethane and polyurea.

Comparing to the coating layers made from the traditional coatings based on polyacrylic polyol, polyester polyol, polyether polyol and/or aliphatic polyisocyanate, the aliphatic polyurea coating layer provided in this invention has obvious improvement in mechanical strength, such as elongation and tensile strength.

Comparing to the traditional two-component spraying polyurea coating, the aliphatic polyurea coating provided in this invention has better manual application property. Comparing to the traditional two-component polyurea coating layer made by the traditional two-component spraying polyurea coatings, the aliphatic polyurea coating layer provided in this invention has better weatherability.

Comparing to the traditional manual application aromatic waterproofing coating, the aliphatic polyurea coating layer provided in this invention has better weatherability.

In addition, the aliphatic polyurea coating provided in this invention has short drying time, good sagging resistance and leveling properties in wet film. The aliphatic polyurea coating can be used to prepare a thick film, i.e. coating film with high film thickness, by one pass application. A thick film of the coatings according to the present invention would be a layer of e.g. ≧50 μm up to several millimeters, preferably between 50 μm and 500 μm, especially preferred between 55 μm and 150 μm. The aliphatic polyurea coating layer has high tolerant to temperature and humidity. The aliphatic polyurea coating is environmentally friendly without containing heavy metal catalyst. This aliphatic polyurea coating, which can be used as a topcoat of the polyurea waterproofing coating layers or aromatic polyurethane waterproofing coating layers, is suitable to be applied outdoor, especially applied as an exposed waterproofing layer on a concrete bridge of a high speed railway or on a roof. Furthermore, the aliphatic polyurea coating provided in the present invention can be applied as a topcoat on a windmill blade, due to the fact that the aliphatic polyurea coating possesses good abrasion resistance and good weatherability.

### EXAMPLES

The present invention is illustrated through the following Examples, and these Examples are only used to illustrate the present invention, rather than limit the scope of the present invention in any way.

The Materials Mentioned in this Context are Illustrated as Follows
Desmodur® XP 2406 NCO-terminated polycarbonate modified isophorone diisocyanate (IPDI) prepolymer, the NCO-content is approximately 2.8% by weight, (based on supply form, i.e. 80% by weight solid content in methoxypropyl acetate), the viscosity is approximately 7000 mPa·s at 23° C., the flashing point is approximately 54° C., the density is approximately 1.08 g/cm³ at 20° C. Available from Bayer Materialscience (China) Co., Ltd.
Desmodur® VP LS 2371 NCO-terminated polyether modified isophorone diisocyanate (IPDI) prepolymer, the solid content is 100% by weight, the NCO-content is approximately 3.7% by weight, (based on supply form), the viscosity is approximately 11000 mPa·s at 23° C., the flashing point >250° C., the density is approximately 1.04 g/cm³ at 20° C. Available from Bayer Materialscience (China) Co., Ltd.
   Desmodur® N75 BA Biuret of hexamethylene diisocyanate (HDI), the solid content is 75 wt. %, the NCO-content is approximately 16.5±0.3wt. %, (based on supply form, i.e. 75% by weight solid content in n-butyl acetate), the viscosity is approximately 160±50 mPa·s at 23° C., the flashing point is approximately 35° C., the density is approximately 1.07 g/cm³ at 20° C. Available from Bayer Materialscience (China) Co., Ltd.
Desmophen® NH 14 20 Aliphatic secondary diamine with cycloaliphatic modified, the amino equivalent is approximately 277 (based on supply form), the viscosity is approximately 900-2000 mPa·s at 25° C., the flashing point is approximately 145° C., the density is approximately 1.076 g/cm³ at 20° C. Available from Bayer MaterialScience (China) Co., Ltd.
Disperbyk® 115 Solution of high molecular weight block copolymer with pigment affinity groups, the amino equivalent is approximately 25 mgKOH/g, the density is approximately 0.96 g/ml at 20° C., the nonvolatile component is approximately 52%, the flashing point >24° C., the ratio of xylene to butyl acetate to methoxypropylacetate in solvent is 5:1:1. Available from BYK-Chemie Co., Ltd.
Ti-pure R-706 Chloride prepared rutile titanium dioxide pigment, the TiO₂ content is higher than or equal to 93 wt. %, the average particle size is approximately 0.36 μm, the oil absorption is approximately 13.9 g/100 g, the pH value is approximately 8.2. Available from Dupont Co., Ltd.
FW200 High color amorphous carbon black, the basic particle size is approximately 13 nm, the specific surface is approximately 550 m²/g. Available from Evonik Degussa Co., Ltd.
BYK® 320 Polyether modified methylalkylpolysiloxane copolymer, the density is approximately 0.86 g/ml at 20° C., the nonvolatile component is approximately 52%, the flashing point is approximately 38° C., the solvent is gasoline/methoxypropylacetate(9/1). Available from BYK-Chemie Co., Ltd.
BYK® 333 Polyether modified dimethylpolysiloxane copolymer, the density is approximately 1.04 g/ml at 20° C., the nonvolatile component ≧97%, the flashing point >100° C. Available from BYK-Chemie Co., Ltd.
BYK® A 530 Solution of foam destroying polymers and polysiloxanes, the density is approximately 0.81 g/ml at 20° C., the nonvolatile component is approximately 5% by weight, the flashing point ≧95° C., the solvent is a mixture of hydrocarbon (paraffin series, naphthene series). Available from BYK-Chemie Co., Ltd.
Tinuvin® 292 Bis(1,2,2,6,6-pentamethyl-4-piperidyl)sebacate and methyl 1,2,2,6,6-pentamethyl-4-piperidyl sebacate ester, dynamic viscosity is approximately 400 mPa·s at 20° C. Available from Ciba Co., Ltd.
Tinuvin® 1130 Mixture of benzontriazole, the dynamic viscosity is approximately 7400 mPa·s at 20° C. Available from Ciba Co., Ltd.
Acematt® TS 100 Gas phase silicon dioxide matting, the SiO₂ content is higher than 99.8 wt. %, the average particle size is approximately 10 μm, the oil absorption is approximately 360 g/100 g, the pH value is approximately 6.5. Available from Evonik Degussa Co., Ltd.
Addtive TI Methyl benzene sulfonyl isocyanate, the active ingredient ≧97% b.w., viscosity is 10 mPa·s, the relative density is 1.29, the boiling point is 270° C., the freezing point is 5° C., the flashing point >100° C. Available from Borchers Co., Ltd.
MPA Solvent: methoxypropylacetate. Available from Dow Co., Ltd.
Xylene Solvent: xylene. Available from Shanghai experiment reagent Co., Ltd.
BA Solvent: butyl acetate. Available from Shanghai experiment reagent Co., Ltd.
Desmophen® A 575 X Highly flexible hydroxyl polyacrylate, the OH content is approximately 2.8±0.2wt. % (based on supply form, i.e. 75% by weight solids in xylene), the viscosity is approximately 3500±500 mPa·s at 23° C., the flashing point is approximately 23° C., the density is approximately 1.06 g/cm³ at 20° C. Available from Bayer MaterialScience (China) Co., Ltd.
Desmophen® 670 BA Highly flexible slightly branched hydroxyl polyester, the OH content is approximately 3.5±0.3wt. % (based on supply form, i.e. 80% by weight solids in butyl acetate), the viscosity is approximately 3000±400 mPa·s at 23° C., the flashing point is approximately 32° C., the density is approximately 1.11 g/cm³ at 20° C. Available from Bayer MaterialScience (China) Co., Ltd.
Desmophen® 1652 Highly flexible linear hydroxyl polyester, the OH content is approximately 1.6±0.2wt. %, the viscosity is approximately 11000±2000 mPa·s at 23° C., the flashing point is approximately 218° C., the density is approximately 1.17 g/cm³ at 20° C. Available from Bayer MaterialScience (China) Co., Ltd.
Desmophen® 5028 GT Highly flexible three-functional polypropylene ether polyol, comprising 20% (by weight)polyurethane polyurea as filler, the OH content is approximately 0.86±0.06 wt. %, the viscosity is approximately 3600±400 mPa·s at 25° C., the density is approximately 1.08 g/cm³ at 20° C. Available from Bayer MaterialScience (China) Co., Ltd.
DBTDL Dibutyltin dilaurate, the molecular weight is 631, the tin content is 18.5±5 wt. %. Available from Air Products.
   All viscosity data were determined according to DIN EN ISO 3219/A.3.
   The NCO-contents were determined according to DIN EN ISO 11 909.

### Selection and Pretreatment of the Substrates

Different substrates might be used in the test items of coating provided in the present invention. The selection and pretreatment of the substrates are listed in Table 1 as well as the test items.

TABLE 1
Selection and Pretreatment of the Substrates

| | | The test items for the |
|---|---|---|
| Selection of the substrate | Pretreatment of the substrate | coating |
| Using polyurea waterproofing | Before spraying the paint, wiping | Test for adhesion, chemical |
| coating with a thickness of | the surface of the polyurea water- | resistance, water resistance, |
| 1.8 ± 0.2 mm as a substrate, | proofing coating with a clean paper | and flexibility under low |
| the substrate can be prepared | dipped in acetone | temperature |
| easily, i.e. spraying a polyurea | | |
| waterproofing coating with a | | |
| thickness of 1.8 ± 0.2 mm, | | |
| and peeling it off | | |
| Using glass panel with a | Before spraying the paint, wiping | Test for drying time |
| smooth, flat, clean surface | the surface of the glass panel with | |
| | a clean paper dipped in acetone | |
| Using sanded tin panel with a | Before spraying the paint, using a | Test for flexibility and impact |
| smooth, flat, clean surface | 300 mesh sand paper to sand the | resistance |
| | surface of the tin panel, and wiping | |
| | it with a clean paper dipped in | |
| | acetone | |
| Using sanded aluminum panel | Before spraying the paint, using a | Test for abrasion resistance |
| with smooth, flat, clean surface | 300 mesh sand paper to sand the | |
| | surface of the aluminum panel, and | |
| | wiping it with a clean paper dipped | |
| | in acetone | |
| Using PP panel with a | Before spraying paint, wiping the | Test for elongation and tensile |
| smooth, flat, clean surface | PP panel with a clean paper dipped | strength |
| | in acetone | |
| Using standard Q-panel aluminum | Before spraying paint, wiping the | Test for artificial accelerated |
| panel | Q-panel aluminum panel with a | weathering resistance |
| | clean paper dipped in acetone | |

### Method for Preparing the Coating Film for Testing

The coating film for testing can be applied, but not limited by, air spraying. According to the practical requirements, the thickness of the dry film is 200±10 μm. The coating film is spayed to form a dry film in one pass, if the thickness of dry film reaches 200 μm in one pass. The coating film is spayed to form a dry film in several passes until the thickness of dry film reaches 200±10 μm, if the thickness of dry film can not reach 200 μm in one pass.

### Illustration of Test Items for Examples and Comparative Examples

Elongation is not only one of the most important property for the quality of aliphatic polyurea coating, but also one of the most difficult property to be achieved.

In the Examples and Comparative Examples of the present invention, seven properties of aliphatic polyurea coating, such as elongation, tensile strength, drying time, adhesion, alkali resistance (NaOH 5% 240 h), acid resistance (H₂SO₄ 5% 240 h) and artificial accelerated weathering resistance, are used to test and compare.

### Test Specification of Examples and Comparative Examples

The test items and specification of the Examples and Comparative Examples are listed in Table 2.

TABLE 2
Test Items and Specification of the Samples

| Serial | | | | |
|---|---|---|---|---|
| Number | Test Items | | Specification | Test Method |
| 1 | Color and appearance of | | Light grey, Satin, even colour | Observation |
| | coating film | | | |
| 2 | Solid content % | | ≧60 | GB/T 1725 |
| 3 | Fineness μm | | ≦50 | GB/T 6753.1 |
| 4 | Drying time | Surface | ≦4 | GB/T 1728 |
| | | drying | | |
| | | Hard | ≦24 | GB/T 1728 |
| | | drying | | |

| | | | |
|---|---|---|---|
| 5 | Bending, Φ10 mm | ≦−30° C., no cracking, no peeling | GB/T 6742 |
| 6 | Impact resistance, 100 cm | No cracking, no wrinkling and no flaking | GB/T 1732 |
| 7 | Adhesion (pull off method) | ≧2.5 | GB/T 5210 |
| | MPa | | |
| 8 | Alkali resistance NaOH | 240 h, no blistering, no wrinkling, no | GB/T9274 |
| | 5% 240 h | discoloration, no peeling and other phenomena | |
| 9 | Acid resistance H₂SO₄ | | |
| | 5% 240 h | | |
| 10 | Salt resistance NaCl | | |
| | 3% 240 h | | |
| 11 | Oil resistance, machine oil | | |
| | 240 h | | |
| 12 | Water resistance 48 h | No blistering, no wrinkling, no apparent | GB/T 1733 |
| | | discoloration and no peeling | |
| 13 | Artificial accelerated | No apparent discoloration, no chalking, | GB/T 14522 |
| | weathering resistance | no blistering and no cracking after 1500 h | |
| 14 | Tensile strength MPa | ≧4.0 | GB/T 16777 |
| 15 | Elongation % | ≧200 | |
| 16 | Abrasion resistance | ≦40 | GB/T 1768 |
| | (750 g/500r) mg | | |

Note:
GB is the Chinese National Standard.

Illustration of Raw Material Selected for the Comparative Examples
Highly flexible polyacrylate polyol: Desmophen® A 575 X;
Highly flexible polyester polyol with slightly side chain: Desmophen® 670 BA, Desmophen® 1652;
Highly flexible polypropylene ether polyol with three-functional: Desmophen® 5028 GT;
HDI biuret: Desmodur® N75 BA;
   To optimize the formulation, two or more resins are blended for using. For example, blending Desmophen® A 575 X and Desmophen® 1652, or blending Desmophen® 5028 GT and Desmophen® 670 BA.

### Comparative Example C1

### Preparation of Mixed Solvent

Weigh out MPA, xylene and butyl acetate with the mixing ratio of 1:1:1, put them into a dissolver for 10 minutes stirring at a speed of 500 rpm, fill the mixture in a sealed container.

### Preparation of Color Paste

By using a dispersing plate, put 220 g Desmophen® A575 BA into a dissolver with a cooling water jacket, and then turn on the cooling water;

Add 50 g mixed solvent, 527 g Ti-pure® R-706, and 3 g FW 200 under stirring at a low speed (approximately 800 rpm), then wash the pigment powder stuck on the wall and axes of dissolver by 32.5 g mixed solvent;

Increase the dispersing speed to 3000 rpm and disperse for 15 minutes;

Replace the dispersing plate to a grinding plate, add 150 g mixed solvent and approximately 1000 g grinding beads slowly at low speed (approximately 800 rpm). Increase the dispersing speed to 3000 rpm & keep grinding for 45 minutes. Check fineness, if fineness ≧20 μm, stop the grinding process and turn off the cooling water, the color paste preparation is completed; if fineness >20 μm, continue grinding until the fineness ≦20 μm;

Filter the color paste with 100-200 mesh sieve. The finished color paste should be stored in a sealed container.

### Preparation of Component A

Put 270 g Desmophen® A 575 BA into a dissolver, add 450 g prepared color paste, 150 g Desmophen® 1652, 2 g BYK® 320, 2 g BYK® 333, 2 g BYK® A530, 6 g Tinuvin® 292, 1 g DBTDL (20% b.w. xylene solution), 60 g mixed solvent and 50 g TS100 slowly at a low speed (approximately 1000-1200 rpm), then wash the matting agent stuck on the wall and axes of dissolver container by 8 g mixed solvent. Increase the dispersing speed to 2000 rpm and disperse for 15-20 minutes. Check fineness, if fineness ≦45 μm, stop dispersing; If fineness >45 μm, continue dispersing until the fineness ≦45 μm;

Filter component A with 100-200 mesh sieve, component A should be stored in a sealed container. The prepared component A can be used after 24 hours storage.

### Preparation of Component B

Component B is Desmodur® N 75 BA, no additional processing.

### Application and Test Specimen Preparation

Weigh out component A and component B accurately according to the mixing ratio of 4:1, then manually mixing for 1-3 min. Add an appropriate amount of mixed solvent to adjust the viscosity until flow time of Tu-4 cup is 20±2 s, and the mixture can be used after filtration by 200 mesh sieve. Prepare a test specimen on the corresponding substrate by air spraying, spray 2-3 passes until the dry film thickness reaches 200±10 μm.

Make comparison between the Comparative Example C1 and the Examples, the comparing items & results are listed in Table 3.

### Comparative Example C2

### Preparation of Mixed Solvent

Weigh out MPA, xylene and butyl acetate with the mixing ratio of 1:1:1, put them into a dissolver for 10 minutes stirring at a speed of 500 rpm, fill the mixture in a sealed container.

### Preparation of Color Paste

Put 220 g Desmophen® 670 BA into a dissolver with a cooling water jacket, and turn on the cooling water;

Add 160 g mixed solvent, 20 g Disperbyk® 115, 567 g Ti-pure® R-706, 3 g FW 200 under stirring at a low speed (approximately 800 rpm), then wash the pigment powder stuck on the wall and axes of dissolver by 30 g mixed solvent.

Increase the dispersing speed to 3000 rpm and disperse for 15 minutes;

Replace the dispersing plate to a grinding plate, add 150 g mixed solvent and approximately 1000 g grinding beads slowly at a low speed (approximately 800 rpm). Increase the dispersing speed to 3000 rpm & keep grinding for 45 minutes. Check fineness, if fineness ≦20 μm, stop the grinding process and turn off the cooling water, the color paster preparation is completed; if fineness >20 μm, continue grinding until the fineness ≦20 μm;

Filter the color paster with 100-200 mesh sieve. The finished color paste should be stored in a sealed container.

Preparation of Component A Put 480 g Desmophen® 670 BA into a dissolver, add 295 g prepared color paste, 2 g BYK® 320, 2 g BYK® 333, 2 g BYK® A530, 5 g Tinuvin® 292, 6 g DBTDL (20% b.w. xylene solution), 132 g mixed solvent and 55 g TS100 slowly at a low speed (approximately 1000-1200 rpm), then wash the matting agent stuck on the wall and axes of dissolver container by 20 g mixed solvent. Increase the dispersing speed to 2000 rpm and disperse for 15-20 minutes. Check fineness, if fineness ≦45 μm, stopping dispersing; if fineness >45 μm, continue dispersing until fineness ≦45 μm;

Filter the component A with 100-200 mesh sieve, component A should be stored in a sealed container. The prepared component A can be used after 24 hours storage.

### Preparation of Component B

Component B is Desmodur® N 75 BA, no additional processing.

### Application and Test Specimen Preparation

Weigh out component A and component B accurately according to the mixing ratio of 10:3, then manually mixing for 1-3 min. Add an appropriate amount of mixed solvent to adjust the viscosity until flow time of the Tu-4 cup is 20±2 s, and the mixture can be used after filtration by 200 mesh sieve. Prepare a test specimen on the corresponding substrate by air spraying, spray 2-3 passes until the dry film thickness reaches 200±10 μm.

Make a comparison between the Comparative Example C2 and the Examples, the comparing items & the results are listed in Table 3.

### Comparative Example C3

### Preparation of Mixed Solvent

Weigh out MPA, xylene and butyl acetate with the mixing ratio of 1:1:1, put them into a dissolver for 10 minutes stirring at a speed of 500 rpm, fill the mixture in a sealed container.

### Preparation of Color Paste

Put 220 g Desmophen® 670 BA into a dissolver with a cooling water jacket and turn on the cooling water;

Add 160 g mixed solvent, 20 g Disperbyk® 115, 567 g Ti-pure® R-706, 3 g FW under stirring at a low speed (approximately 800 rpm), then wash the pigment powder stuck on the wall and axes of dissolver by 30 g mixed solvent. Increase the dispersing speed to 3000 rpm and disperse for 15 minutes;

Replace the dispersing plate to a grinding plate, add approximately 1000 g grinding beads slowly at a low speed (approximately 800 rpm). Increase the dispersing speed to 3000 rpm & keep grinding for 45 minutes. Check fineness, if fineness ≦20 μm, stop the grinding process and turn off the cooling water, the color paste preparation is completed; if fineness >20 μm, continue grinding until fineness ≦20 μm;

Filter the color paste with 100-200 mesh sieve. The finished color paste should be stored in a sealed container.

### Preparation of Component A

Put 480 g Desmophen® 670 BA into a dissolver, add 300 g prepared color paste, 400 g Desmophen® 5028 GT, 6 g BYK® 320, 4 g BYK® 333, 4 g BYK® A530, 7 g Tinuvin® 292, 15 g Tinuvin® 1130, 6 g DBTDL (20% xylene solution), 138 g mixed solvent and 60 g TS100 slowly at a low speed (approximately 1000-1200 rpm), then wash the matting agent stuck on the wall and axes of dissolver container by 20 g mixed solvent. Increase the dispersing speed to 2000 rpm and dispersing for 15-20 minutes. Check fineness, if fineness ≦45 μm, stop dispersing; if the fineness >45 μm, continue dispersing until fineness ≦45 μm;

Filter the component A with 100-200 mesh sieve, component A should be stored in a sealed containers. The prepared component A can be used after 24 hours storage.

### Preparation of Component B

Component B is Desmodur® N 75 BA, no additional processing.

### Application and Test Specimen Preparation

Weigh out component A and component B accurately according to the mixing ratio of 144:36, then manually mixing for 1-3 min Add an appropriate amount of mixed solvent to adjust the viscosity until flow time of the Tu-4 cup is 20±2 s, and the mixture can be used after filtration by 200 mesh sieve. Prepare a test specimen on the corresponding substrate by air spraying, spray 2-3 passes until the dry film thickness reaches 200±10 μm.

Make comparison between the Comparative Example C3 and the Examples, the comparing items & results are listed in Table 3.

### Example E1

### Preparation of Mixed Solvent

Weigh out MPA, xylene and butyl acetate with the mixing ratio of 1:1:1, put them into a dissolver for 10 minutes stirring at a speed of 500 rpm, fill the mixture in a sealed container.

### Preparation of Component A

Put 105.3 g Desmophen® NH 1420 into a dissolver with a cooling water jacket and then turn on the cooling water;

Add 7 g Disperbyk® 115, 180 g Ti-pure® R-706, 2.5 g FW 200 under stirring at low speed (approximately 800 rpm), then wash the pigment powder stuck on the wall and axes of dissolver container by 15 g mixed solvent.

Increase the dispersing speed to 3000 rpm and disperse for 15 minutes;

Replace the dispersing plate to a grinding plate, add 15 g mixed solvent and approximately 320 g grinding beads slowly at a low speed (approximately 800 rpm). Increase the dispersing speed to 3000 rpm & keep grinding for 45 minutes, Check fineness. If fineness ≦20 μm, stop the grinding process and turn off the cooling water, continue to the next process, if fineness >20 μm, continue grinding until fineness ≦20 μm;

Replace the grinding plate to a dispersing plate, add 3 g BYK® 320, 2 g BYK® 333, 2 g BYK® A530, 5 g Tinuvin® 292, 10 g Tinuvin® 1130, 118.2 g mixed solvent and 25 g TS100 into dissolver slowly at a low speed (approximately 1000-1200 rpm), then wash the matting agent stuck on the wall and axes of dissolver by 10 g mixed solvent. Disperse for 15 min. Check fineness, if fineness ≦45 μm, stop dispersing, turn off the cooling water; if the fineness >45 μm, continue dispersing until fineness ≦45 μm;

Filter the component A with 100-200 mesh sieve, component A should be stored in a sealed containers. The prepared component A can be used after 24 hours storage.

### Preparation of Component B

Put 342.6 g Desmodur® XP 2406 into a dissolver, add 42.8 g Desmodur® N 75 BA, 113.6 g butyl acetate and 1 g Additive TI under stirring at a low speed (approximately 800-1000 rpm), stir for 10 min, the component B preparation is completed. Component B should be stored in sealed container properly.

### Application and Test Specimen Preparation

Weigh out component A and component B accurately according to the mixing ratio of 1:1, then manually mixing for 1-3 minutes. Add an appropriate amount of mixed solvent to adjust the viscosity until flow time of the Tu-4 cup is 20±2 s, and the mixture can be used after filtration by 200 mesh sieve. Prepare a test specimen on the corresponding substrate by air spraying, dry film thickness can reach 200±10 μm by spraying one pass.

Make comparison between the Example E1 and Comparative Examples, the comparing items & the results are listed in Table 3.

The complete test items and results of Example E1 are listed in Table 4.

### Example E2

### Preparation of Mixed Solvent

Weigh out MPA, xylene and butyl acetate with the mixing ratio of 1:1:1, put them into a dissolver for 10 minutes stirring at a speed of 500 rpm remove, fill the mixture in a sealed container.

### Preparation of Component A

Put 108 g Desmophen® NH 1420 into a dissolver with a cooling water jacket and then turn on the cooling water;

Add 7 g Disperbyk® 115, 187 g Ti-pure® R-706 and 2.2 g FW 200 under stirring at low speed (approximately 800 rpm), then wash the pigment powder stuck on the wall and axes of dissolver by 17.3 g mixed solvent.

Increase the dispersing speed to 3000 rpm and disperse for 15 minutes;

Replace the grinding plate to a dispersing plate, add 10 g mixed solvent and approximately 330 g grinding beads slowly by at a low speed (approximately 800 rpm), increase the dispersing speed to 3000 rpm & keep grinding for 45 minutes. Check fineness, if fineness ≦20 μm, stop the grinding process, turn off the cooling water and start the next process; if fineness >20 μm, continue grinding until fineness ≦20 μm;

Replace the grinding plate to a dispersing plate, adding 3 g BYK® 320, 2 g BYK® 333, 2 g BYK® A530, 5 g Tinuvin® 292, 10 g Tinuvin® 1130, 113.5 g mixed solvent and 25 g TS100 into dissolver container slowly at a low speed (approximately 1000-1200 rpm), then wash the matting agent stuck on the wall and axes of dissolver by 8 g mixed solvent. Disperse for 15 minutes. Check fineness, if fineness ≦45 μm, stop dispersing, turn off the cooling water; if fineness >45 μm, continue dispersing until fineness ≦45 μm.

Filter the component A with 100-200 mesh sieve, component A should be stored in a sealed containers. The prepared component A can be used after 24 hours storage.

### Preparation of Component B

Put 240 g Desmodur® VP LS 2371 into a dissolver, add 48 g Desmodur® N 75 BA, 211 g butyl acetate and 1 g Additive TI slowly under stirring at a low speed (approximately 800-1000 rpm), stir for 10 min, component B preparation is completed. Component B should be stored in sealed container properly.

### Application and Test Specimen Preparation

Weigh out component A and component B accurately according to the mixing ratio of 1:1, then manually mixing for 1-3 min Add an appropriate amount of mixed solvent to adjust the viscosity until flow time of the Tu-4 cup is 20±2 s, and the mixture can be used after filtration by 200 mesh sieve. Prepare a test specimen on the corresponding substrate by air spraying, dry film thickness can reach 200±10 μm by spraying one pass.

Make comparison between the Example E2 and Comparative Examples, the comparing items and results are listed in Table 3.

The complete test items and results of Example E2 are listed in Table 4.

TABLE 3
Comparison items and results of Example E1, E2 and Comparative Example C1, C2, C3

| | | | | | Comparative | Comparative | Comparative |
|---|---|---|---|---|---|---|---|
| Serial | | | Example | Example | Example | Example | Example |
| Number | Test Items | | E1 | E2 | C1 | C2 | C3 |
| 1 | Drying time | Surface drying h | ~2.5 | ~1.5 | ~2.5 | ~4 | ~4 |
| | | Hard drying h | ~12 | ~5 | ~13 | ~18 | ~18 |

| | | | | | | |
|---|---|---|---|---|---|---|
| 2 | elongation % | ~480 | ~360 | ~106 | ~130 | ~210 |
| 3 | Tensile strength MPa | ~15 | ~16 | ~13.5 | ~6 | ~3.5 |
| 4 | Adhesion (pull method) MPa | ≧8 | ≧10 | ~5 | ~5 | ~1 |
| 5 | Alkali resistance NaOH 5% 240 h | ≧240 h | ≧480 h | ≦240 | ≦240 | ≦240 |
| 6 | Acid resistance H₂SO₄ 5% 240 h | ≧240 h | ≧480 h | ≦240 | ≦240 | ≦240 |
| 7 | Artificial accelerated | ≧2000 h | ≧1500 h | ≧1500 h | ≧1500 h | ≦100 |
| | weathering resistance test | | | | | |

Note:
the corresponding coating of the above Examples and Comparative Examples are listed below:
Example E1: NCO-terminal polycarbonate modified IPDI prepolymer (Desmodur ® XP 2406), secondary aliphatic diamine with alicyclic compound modified (Desmophen ® NH1420).
Example E2: NCO-terminal polyether modified IPDI prepolymer (Desmodur ® VP LS 2371), secondary aliphatic diamine with alicyclic compound modified (Desnophen ® NH 1420).
Comparative Example C1: Highly flexible hydroxyl polyacrylate (Desmophen ® A575 X), Highly flexible linear hydroxyl polyester (Desmophen ® 1652), HDI Biuret (Desmodur ® N75).
Comparative Example C2: Highly flexible slightly branched hydroxyl polyester (Desmophen ® 670 BA), HDI Biuret (Desmodur ® N75).
Comparative Example C3: Highly flexible three-functional polypropylene hydroxyl polyether (Desmophen ® 5028 GT), Highly flexible slightly branched hydroxyl polyester (Desmophen ® 670 BA), HDI Biuret (Desmodur ® N75).

Table 3 shows that, Comparative Example C1, C2 based on hydroxyl acrylate and hydroxyl polyester, the elongation can not reach 200%, the acid and alkali resistance is poor; Comparative Example C3 based on hydroxyl polyether can reach 200% elongation, but the tensile strength is <4 MPa, the adhesion and UV resistance are also poor; furthermore, the formulations of C1,C2,C3 require a large amount of organic tin catalysts for curing at room temperature, however, organic tin may cause pollution to environment. By comparing, Example E1 and E2 showed better properties than Comparative examples, especially the properties of elongation and UV resistance. In addition, the formulations of Example E1 and E2 are environmentally friendly, due to no heavy metal catalyst in Example E1 and E2.

TABLE 4
Complete test results of Examples E1, E2

| | | | | | Specification |
|---|---|---|---|---|---|
| | | | | | (Reference Ministry |
| | | | | | of Railway |
| | | | | | Technology |
| Serial | | | | | specification |
| Number | Test Items | | Example E1 | Example E2 | 2009-54 File) |
| 1 | Color and appearance | | light grey, | light grey, | light grey, |
| | of coating film | | satin, | satin, | satin, |
| | | | even color | even color | even color |
| 2 | Non-volatile content % | | ~61 | ~62 | ≧60 |
| 3 | Fineness μm | | ≦45 | ≦45 | ≦50 |
| 4 | Drying time | Surface | ~2.5 | ~1.5 | ≦4 |
| | | drying h | | | |
| | | Hard | ~12 | ~5 | ≦24 |
| | | drying h | | | |

| | | | | |
|---|---|---|---|---|
| 5 | Flexural properties | ≦−30° C., | ≦−30° C., | ≦−30° C., |
| | Φ10 mm bending | no cracking, | no cracking, | no cracking, |
| | | no peeling | no peeling | no peeling |
| 6 | Impact resistance, | No cracks, | No cracks, | No cracks, |
| | drop height 100 cm | no wrinkles, | no wrinkles, | no wrinkles, |
| | | no flaking | no flaking | no flaking |
| 7 | Adhesion (pull | ≧8 | ≧10 | ≧2.5 |
| | method) MPa | | | |
| 8 | Alkali resistance | ≧240 h | ≧480 h | 240 h, the coat has |
| | NaOH 5% 240 h | | | no blistering, |
| 9 | Acid resistance H₂SO₄ | ≧240 h | ≧480 h | no wrinkling, |
| | 5% 240 h | | | no discoloration, |
| 10 | Salt resistance NaCl | ≧240 h | ≧480 h | nopeeling, |
| | 10% 240 h | | | no other phenomena |
| 11 | Oil resistance machine | ≧240 h | ≧480 h | |
| | oil 240 h | | | |
| 12 | Water resistance 48 h | No blistering, | No blistering, | no blistering, |
| | | no wrinkling, | no wrinkling, | no wrinkling, |
| | | no discoloration, | no discoloration, | no discoloration, |
| | | no peeling | no peeling | no peeling |
| 13 | Artificial accelerated | ≧1500 h | ≧1500 h | no apparent dis- |
| | weathering resistance | (see Table 5) | (see Table 5) | coloration and |
| | test | | | chalking, |
| | | | | no bilstering, |
| | | | | no cracking after |
| | | | | 1500 h |
| 14 | Tensile strength (MPa) | ~15 | ~16 | ≧4.0 |
| 15 | Elongation % | ~480 | ~360 | ≧200 |
| 16 | Abrasion resistance | ≦10 | ≦25 | ≦40 |
| | (750 g/500r) mg | | | |

TABLE 5
Artificial Accelerated Weathering Resistance Test Results of E1, E2

| | Example E1 | | | Example E2 | | |
|---|---|---|---|---|---|---|
| Project | | | Color | | | Color |
| time | 60° gloss | 85° gloss | difference ΔE | 60° gloss | 85° gloss | difference ΔE |
| 0 h | 15 | 39 | — | 2.8 | 19.5 | — |
| 500 h | 15.5 | 35.2 | 0.26 | 2 | 21.3 | 0.87 |
| 1000 h | 16.6 | 36.8 | 1.06 | 1.8 | 24.8 | 1.17 |
| 1500 h | 17.6 | 40.4 | 1.28 | 2.3 | 30.3 | 1.72 |
| 2000 h | 19 | 41.9 | 1.49 | 2 | 30 | 1.91 |

Note:
the test condition is QUV-A, 0.68 W/m2/nm, 340 nm; Exposure Cycle: continuous UV at 60° C.

Table 4 and Table 5 show that, the aliphatic polyurea coating layer applied from Example E1 and E2 can achieve: elongation ≧200%, tensile strength ≧4 MPa, no apparent discoloration and chalking, no blistering and no cracking after 1500 h artificial accelerated aging test.

In order to enhance the guidance of the present invention in practical application, we adjust the ratio of the IPDI prepolymer in the formulation based on Example E1 and evaluate its influence on the working time (pot life), drying time, elongation and tensile strength. Detailed results listed in Table 6.

TABLE 6
Influence of Different Ratio of IPDI Prepolymer on the working
Time, Drying time, Elongation and Tensile Strengthc

| | | | XP | XP | XP | XP | Pure |
|---|---|---|---|---|---|---|---|
| | | Pure | 2406:N75 = | 2406:N75 = | 2406:N75 = | 2406:N75 = | XP |
| Test Items | | N 75 | 5:1 | 8:1 | 10:1 | 15:1 | 2406 |
| Working time, h | | 0.33 | 1.5 | 2.5 | 2.67 | 3 | 3.33 |
| Drying time | Surface drying, h | 0.42 | 0.83 | 2 | 3 | 3.67 | 18.33 |
| | Hard drying, h | 0.83 | 3 | 12 | 15 | 20 | 25.83 |

| | | | | | | |
|---|---|---|---|---|---|---|
| Elongation % | 6 | 290 | 450 | 500 | 630 | 1100 |
| Tensile strength, MPa | 35 | 17.8 | 15.2 | 12.1 | 8 | 6 |

Table 6 shows that, changing the ratio of Desmodur® XP 2406 and Desmodur® N 75 enables adjustments below: working time of the aliphatic polyurea coating in the range of 0.33 h to 3.33 h, surface drying time of the aliphatic polyurea coating in the range of 0.42 h to 18.33 h, elongation of the aliphatic polyurea coating in the wide range of near 0% to more than 1000%, tensile strength of the aliphatic polyurea coating in the range of 6 MPa to 35 MPa.

Furthermore, based on Example E1, the present invention tests the influence of temperatures on the application of the coating. Detailed results listed in Table 7.

TABLE 7
Influence of temperatures on the working time and drying time
of Example E1

| | | Application temperature | | |
|---|---|---|---|---|
| Test Items | | 5° C. | 23° C. | 45° C. |
| Working time, h | | 3 | 2.5 | 2.5 |
| Drying time | Surface | 1.9 | 2 | 2 |
| | drying | | | |
| | time, h | | | |
| | Hard drying | 15 | 12 | 12 |
| | time, h | | | |

Table 7 shows that, the aliphatic polyurea coating provided in the present invention has high tolerance to different temperatures. The working time and drying time of the coating is close under both low temperature condition of 5° C. and high temperature condition of 45° C. It reveals that the aliphatic polyurea coating provided in this invention has excellent application properties.

To sum up, the present invention selects NCO-terminated polycarbonate diol modified and/or polyether polyol modified isophorone diisocyanate prepolymer, HDI biuret and the sterically hindered secondary aliphatic diamines as the basis of coating, and obtains an aliphatic polyurea coating with excellent properties. Comparing to those coatings based on hydroxyl acrylic, hydroxyl polyester, hydroxyl polyether with aliphatic polyisocyanates, the coating provided in this invention makes obvious improvements in elongation, tensile strength, chemical resistance, weather resistance, adhesion and application etc. In addition, it is easy to adjust the application properties or the physical and chemical properties of the aliphatic polyurea coating by adjusting the formulation of the coating (for example, adjusting the ratio of Desmodur® XP 2406 to Desmodur® N 75 BA).

Although the present invention is illustrated through Examples, it is not limited by these Examples in any way. Without departing from the spirit and scope of this invention, those skilled in the art can make any modifications and alternatives. And the protection of this invention is based on the scope defined by the claims of this application.

1-16. (canceled)

17. An aliphatic polyurea coating comprising a product mixed by the components A, B and C:
A) 30-50 parts by weight of NCO-terminated polycarbonate diol modified and/or polyether polyol modified isophorone diisocyanate (IPDI) prepolymer;
B) 3-15 parts by weight of hexamethylene diisocyanate (HDI) oligomers; and
C) 10-25 parts by weight of amino resin comprising sterically hindered secondary aliphatic diamines.

18. The aliphatic polyurea coating as claimed in claim 17, wherein the amount of the NCO-terminated polycarbonate diol modified and/or polyether polyol modified isophorone diisocyanate prepolymer is 33-40 parts by weight.

19. The aliphatic polyurea coating as claimed in claim 17, wherein the average molecular weight of the NCO-terminated polycarbonate diol modified and/or polyether polyol modified isophorone diisocyanate (IPDI) prepolymer is 1500-3500, the NCO-content is 2.5-5.0% by weight, based on 100% by weight of the NCO-terminated polycarbonate diol modified and/or polyether polyol modified isophorone diisocyanate (IPDI) prepolymer.

20. The aliphatic polyurea coating as claimed in claim 17, wherein the amount of the hexamethylene diisocyanate(HDI) oligomers is 4-6 parts by weight.

21. The aliphatic polyurea coating as claimed in claim 17, wherein the hexamethylene diisocyanate (HDI) oligomers is selected from the group consisting of hexamethylene diiso-cyanate trimer, hexamethylene diisocyanate biuret and hexamethylene diisocyanate uretdion.

22. The aliphatic polyurea coating as claimed in claim 17, wherein the NCO-content of the hexamethylene diisocyanate (HDI) oligomers is 10-25% by weight, based on 100% by weight of the hexamethylene diisocyanate (HDI) oligomers.

23. The aliphatic polyurea coating as claimed in claim 17, wherein the amount of the amino resin comprising sterically hindered secondary aliphatic diamine is 12-17 parts by weight.

24. The aliphatic polyurea coating as claimed in claim 17, wherein the amino resin comprising sterically hindered secondary aliphatic diamine is selected from the group consisting of secondary aliphatic diamine with alicyclic compound modified, secondary aliphatic diamine with branched alicyclic compound modified and secondary aliphatic diamine with line aliphatic compound modified.

25. The aliphatic polyurea coating as claimed in claim 17, wherein the amino equivalent of the amino resin comprising sterically hindered secondary aliphatic diamine is 200-400.

26. A method for preparing an aliphatic polyurea coating, comprising the step of mixing the components including A, B and C:
A) 30-50 parts by weight of NCO-terminated polycarbonate diol modified and/or polyether polyol modified isophorone diisocyanate (IPDI) prepolymer;
B) 3-15 parts by weight of hexamethylene diisocyanate (HDI) oligomers; and
C) 10-25 by weight of amino resin comprising sterically hindered secondary aliphatic diamines.

27. The method as claimed in claim 26, wherein the amount of the NCO-terminated polycarbonate diol modified and/or polyether polyol modified isophorone diisocyanate (IPDI) prepolymer is 33-40 parts by weight.

28. The method as claimed in claim 26, wherein the amount of the hexamethylene diisocyanate (HDI) oligomers is 4-6 parts by weight.

29. The method as claimed in claim 26, wherein the hexamethylene diisocyanate (HDI) oligomers is selected from the group consisting of hexamethylene diisocyanate trimer, hexamethylene diisocyanate biuret and hexamethylene diisocyanate uretdion.

30. The method as claimed in claim 26, wherein the amount of the amino resin comprising sterically hindered secondary aliphatic diamine is 12-17 parts by weight.

31. The method as claimed in claim 26, wherein the amino resin comprising sterically hindered secondary aliphatic diamine is selected from the group consisting of secondary aliphatic diamine with alicyclic compound modified, secondary aliphatic diamine with branched alicyclic compound modified and secondary aliphatic diamine with line aliphatic compound modified.

32. An aliphatic polyurea coating layer, wherein the layer is produced by applying the aliphatic polyurea coating of claim 17 to a substrate.

33. An aliphatic polyurea coating layer comprising the aliphatic polyurea coating of claim 17.
